(19) United States
(12) Patent Application Publication
(10) Pub. No.: US 2010/0023368 A1
(43) Pub. Date: Jan. 28, 2010

(54) DYNAMIC REQUEST WORKFLOW MANAGEMENT METHOD AND SYSTEM

(75) Inventor: Peter A. HOUBA, Wesley Chapel, FL (US)

Correspondence Address: VERIZON;PATENT MANAGEMENT GROUP, 1320 North Court House Road, 9th Floor, ARLINGTON, VA, 22201-2909, US

(73) Assignee: Verizon Data Services LLC, Temple Terrace, FL (US)

(21) Appl. No.: 12/180,826

(22) Filed: Jul. 28, 2008

(51) Int. Cl. G06Q 10/00

(52) U.S. Cl. 705/9

(57) ABSTRACT

A system includes a workflow assignment server including a web server to allow a user device to communicate with the system over a network. The system also includes an application server, a data store, a request form engine, and a workflow engine. The application servers include one or more processors to manage inputs from the user device. The data stores include request templates and one or more sets of data to configure a request form. The request form engine assembles a request form based on the request templates and the one or more sets of data, the assembling being initiated by a signal from one of the one or more application servers. The workflow engine receives a completed request form from one of the application servers and automatically assign one or more approvers for the request.

### BACKGROUND INFORMATION

In any type of organization, many individuals or organization units may make access requests, requests for services, or any other type of requests. Traditionally, organizations have attempted to manage workflow of such requests through the use of paper processes, telephone communications, faxes, or other traditional business process. With the emergence of computer-implemented request systems, there are many methods and systems for creating and controlling the workflow of requests. However, the request configuration and workflow management capabilities of these systems are often not flexible enough to handle a large number of different types of requests.

### BRIEF DESCRIPTION OF THE DRAWINGS

FIG. 1 depicts an exemplary work flow management system in which exemplary embodiments described herein may be implemented;

FIG. 2 is a diagram of an exemplary device that may be used in the system of FIG. 1;

FIG. 3 is a block diagram illustrating exemplary components of the application server(s) of FIG. 1;

FIG. 4 is a block diagram illustrating exemplary components of the data store(s) of FIG. 1;

FIG. 5A-5E are exemplary request templates with template form controls;

FIG. 6 is a functional block diagram illustrating exemplary interaction of components of FIGS. 1, 3 and 4;

FIG. 7 is a functional block diagram illustrating exemplary interaction of components of the request forms data store of FIG. 4;

FIG. 8 is a flow chart illustrating exemplary operations performed by the workflow management system of FIG. 1;

FIG. 9 is a flow chart illustrating exemplary operations performed by the workflow engine of FIGS. 1 and 4; and

FIG. 10 provides sections of an exemplary approval form according to implementations described herein.

### DETAILED DESCRIPTION OF PREFERRED EMBODIMENTS

The following detailed description refers to the accompanying drawings. The same reference numbers in different drawings may identify the same or similar elements. Also, the following detailed description does not limit the invention.

Implementations described herein may provide a system and methods for creating a request form using predesigned request form templates and controls, for assigning approvers to the request form or to the request form controls, and for managing a workflow for the request. A request system including the system and methods described herein may provide functionality to setup a request form and may dynamically route a request from a requestor to one or more approvers based on the requestor's input. Tools for creating, managing, and routing requests may be provided. The system and methods described herein may be applied, for example, to any centralized computer-based request system within an organization, thus offering flexibility in request and workflow configuration and execution processes.

As referred to herein, a “request form” may be an electronic form that can be completed by a user to identify a request (e.g., a request for access or services) in a workflow management system. As referred to herein, a “request” may be a completed request form that is submitted through a workflow management system.

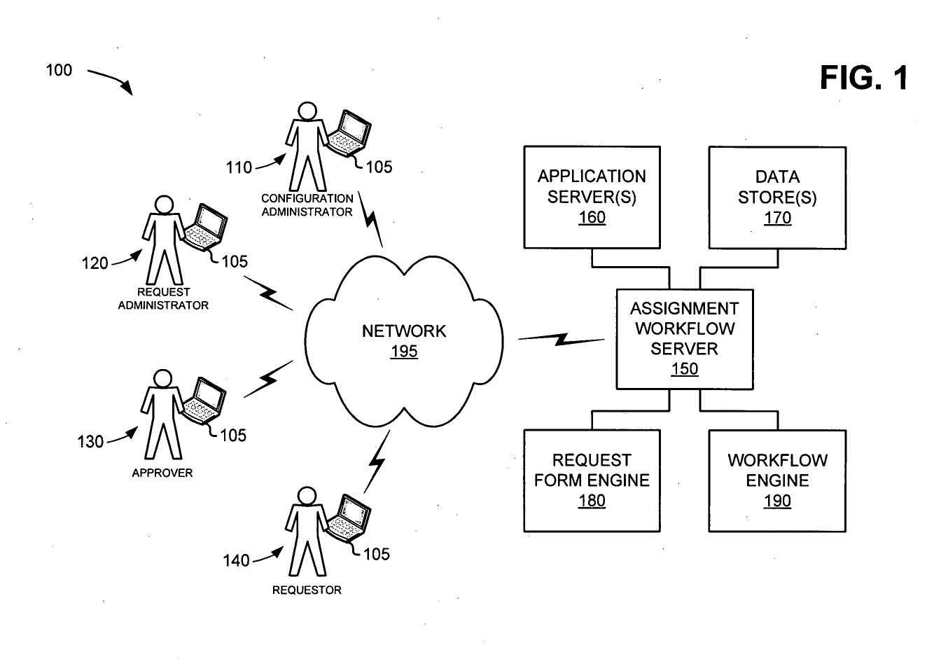

FIG. 1 depicts an exemplary workflow management system 100 in which systems and methods described herein may be implemented. Workflow management system 100 may include multiple components to facilitate the creation, submission and approval of workflow requests. The system may include a configuration administrator 110, a request administrator 120, an approver 130, a requestor 140, (each referred to herein generically as a “user” and collectively as “users”) and an assignment workflow server 150 interconnected by a network 195. As shown in FIG. 1, a user device 105 may be associated with each of configuration administrator 110, request administrator 120, approver 130 and requester 140.

User device 105 include a personal computer, a laptop, a personal communications system (PCS) terminal (e.g., that may combine a cellular radiotelephone with data processing and data communications capabilities), a personal digital assistant (PDA) (e.g., that can include a radiotelephone, a pager, Internet/intranet access, etc.), a radiotelephone, or other types of computation or communication devices, threads or processes running on these devices, and/or objects executable by these devices. In one implementation, user device 105 may include any device that is capable of accessing a software application or a web-based application (e.g., provided by assignment workflow server 150) that enables a user of user device 105 to request, review, edit, etc. a request form.

Configuration administrator 110, request administrator 120, approver 130, and requestor 140 may be users of one or more user devices 105 capable of communicating over network 195 to provide information to, and receive information from, assignment workflow server 150. Configuration administrator 110, request administrator 120, approver 130, and requestor 140 may connect to network 195 via one or more user devices 105 via wired and/or wireless connections. In one implementation, configuration administrator 110, request administrator 120, approver 130, and requestor 140 may use the same user device 105 but have different account access. For example, a user may be provided with a user name and password that allows the user to access stored information from a server (such as assignment workflow server 150) according to the rights (e.g., administrator rights, requestor rights, etc.) granted with the account. As used herein, the terms “user” and “users” are intended to be broadly interpreted to include a user device and a user of a user device (e.g., a configuration administrator, request administrator, approver, or requester).

Assignment workflow server 150 may include or be operatively connected to an application server(s) 160, a data store(s) 170, a request form engine 180, and a workflow engine 190. Assignment workflow server 150 may also include a web server to facilitate network connections with configuration administrator 110, request administrator 120, approver 130, and/or requester 140.

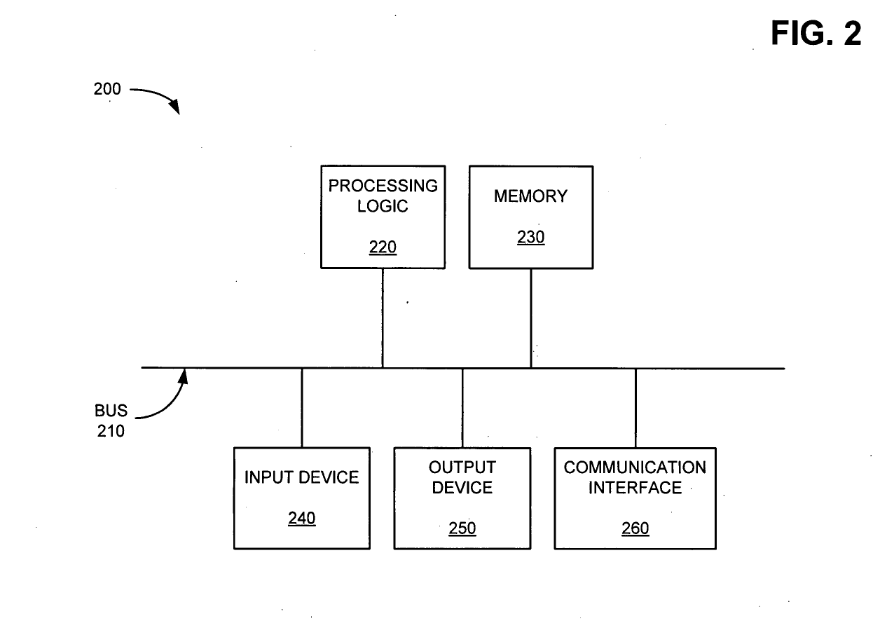

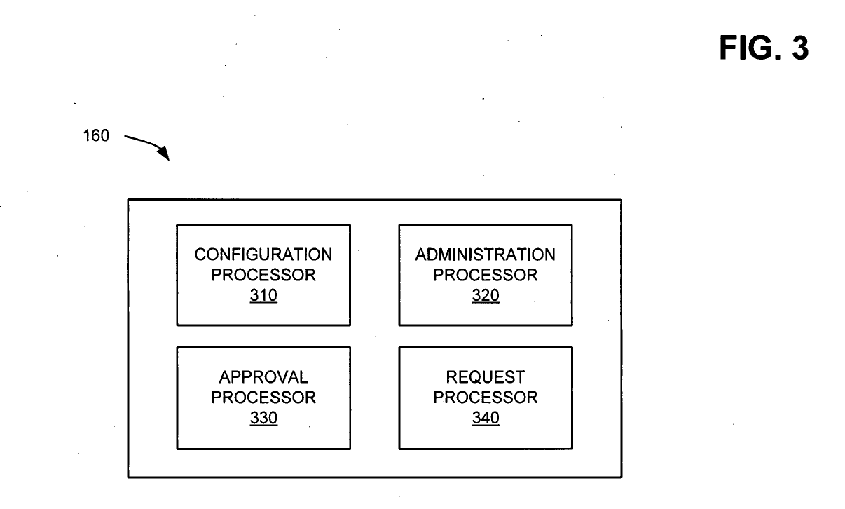

Application server(s) 160 may include one or more processors to manage configuration processes, administration processes, requests, and/or approval processes for workflow management system 100. Further details of application server(s) 160 are provided below in connection with FIGS. 2 and 3.

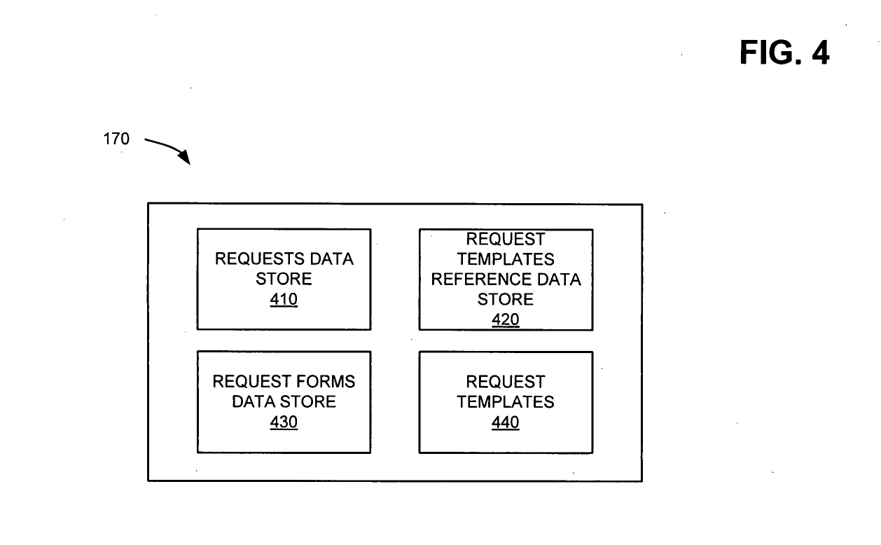

Data store(s) 170 may include one or more data repositories (e.g., databases) that may contain descriptions of the individual elements (or components) of the service. For example, data store(s) 170 may include one or more sets of data to assist application server(s) 160, request form engine 180, and workflow engine 190 to, for example, create custom-designed templates, configure request forms, prepare requests, and track approvals. Further details of data store(s) 170 are provided below in connection with FIG. 4.

Request form engine 180 may assemble information from data store(s) 170 to provide request forms to a user, such as to request administrator 120, approver 130, and/or requester 140. For example, request form engine 180 may receive information from a request form template and request form data stores to display request forms on the display of request administrator 120, approver 130, and/or requestor 140.

Workflow engine 190 may receive information from applications server(s) 160 to disseminate requests and track requests through the approval process. For example, workflow engine 190 may assigns approvers to the request, based on input provided by the requester. Workflow engine 190 may also determine the request status of a particular request in response to, for example, an inquiry from an administrator, a requestor and/or an approver.

Network 195 may include a local area network (LAN), a wide area network (WAN), a metropolitan area network (MAN), an intranet, the Internet, or a combination of networks. In one implementation, network 195 may serve as communication tool between assignment workflow server 150 and the user devices 105 of configuration administrator 110, request administrator 120, approver 130, and requestor 140. In another implementation, network 195 may also connect assignment workflow server 150 to application server(s) 160, data store(s) 170, request form engine 180, and/or workflow engine 190.

One configuration administrator, one request administrator, one approver, one requester, one assignment workflow server (including one application server, one data store, one request form engine, and one workflow engine) and one network have been illustrated in FIG. 1 for simplicity. In practice, there may be more or fewer users, servers, and/or networks. Also, in some instances, one or more of application server(s) 160, data store(s) 170, request form engine 180, and workflow engine 190 may perform one or more functions described as being performed by another one or more of application server(s) 160, data store(s) 170, request form engine 180, and workflow engine 190.

FIG. 2 is an exemplary diagram of a device 200 that may correspond to any of assignment workflow server 150, application server(s) 160, and/or the user devices 105 of configuration administrator 110, request administrator 120, approver 130, and/or requester 140. As illustrated, device 200 may include a bus 210, processing logic 220, a memory 230, an input device 240, an output device 250, and a communication interface 260. In other implementations, device 200 may include fewer, additional, or different components that aid in receiving, transmitting, and/or processing data. Moreover, other configurations are possible.

Bus 210 may include a path that permits communication among the components of device 200. Processing logic 220 may include any type of processor or microprocessor that interprets and executes instructions. In other implementations, processing logic 220 may be implemented as, or include, an application specific integrated circuit (ASIC), a field programmable gate array (FPGA), or the like. Memory 230 may include a random access memory (RAM) or another type of dynamic storage device that stores information and instructions for execution by processing logic 220, a read only memory (ROM) or another type of static storage device that stores static information and instructions for the processing logic 220, and/or some other type of magnetic or optical recording medium and its corresponding drive for storing information and/or instructions.

Input device 240 may include a mechanism that permits an operator to input information to device 200, such as a keyboard, a mouse, a pen, a microphone, voice recognition and/or biometric mechanisms, etc. Output device 250 may include a mechanism that outputs information to the operator, including a display, a printer, a speaker, etc. Communication interface 260 may include any transceiver-like mechanism that enables device 200 to communicate with other devices and/or systems. For example, communication interface 260 may include mechanisms for communicating with another device or system via a network, such as network 195.

As described herein, device 200 may perform certain operations in response to processing logic 220 executing software instructions contained in a computer-readable medium, such as memory 230. A computer-readable medium may be defined as a physical or logical memory device. The software instructions may be read into memory 230 from another computer-readable medium, such as a storage device, or from another device via communication interface 260. The software instructions contained in memory 230 may cause processing logic 220 to perform processes described herein. Alternatively, hardwired circuitry may be used in place of or in combination with software instructions to implement processes described herein. Thus, implementations described herein are not limited to any specific combination of hardware circuitry and software.

FIG. 3 provides a block diagram illustrating exemplary components of application server(s) 160 of FIG. 1. In one implementation, application server 160 may include configuration processor 310, administration processor 320, approval processor 330, and request processor 340. In another implementation, configuration processor 310, administration processor 320, approval processor 330, and request processor 340 may be distributed among two or more application servers 160.

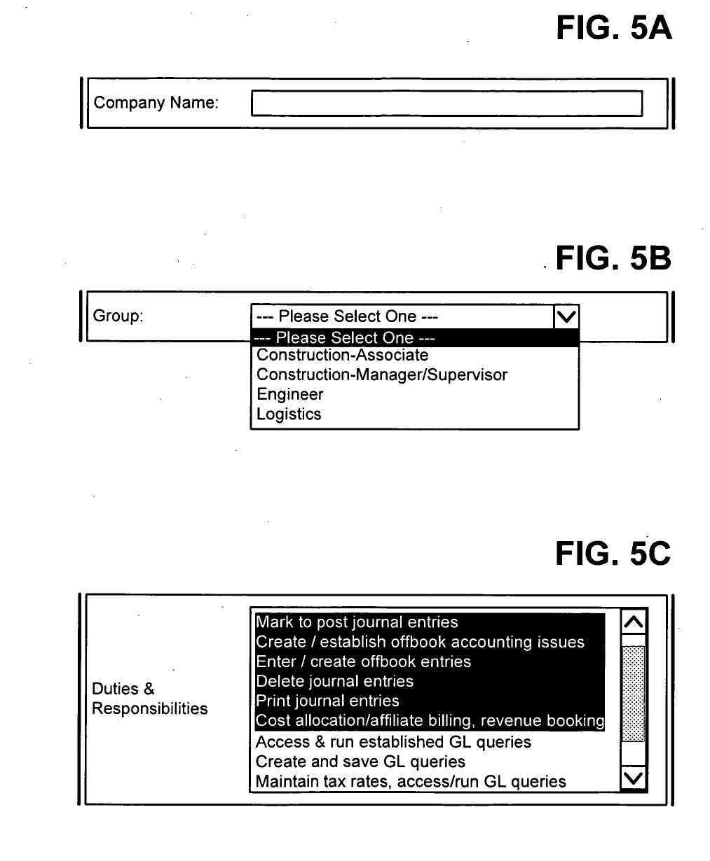

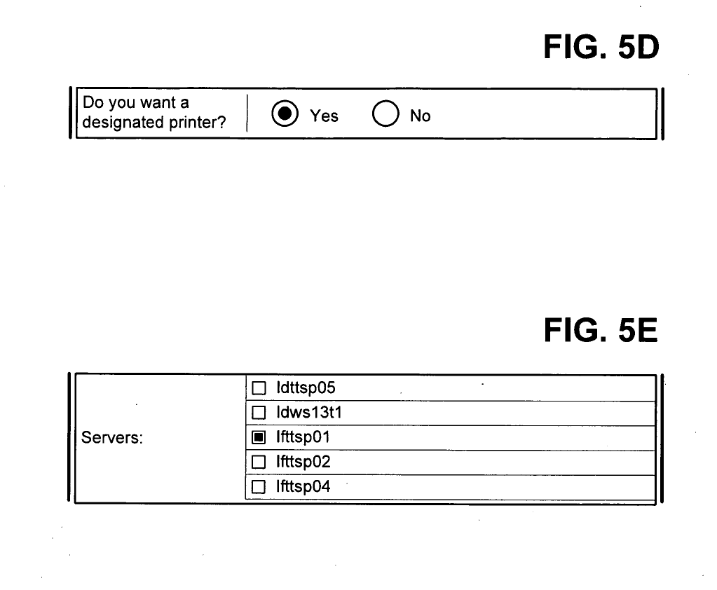

Configuration processor 310 may include hardware- and/or software-based logic to perform form configuration functions on application server(s) 160. For example, according to one implementation of the present invention, configuration processor 310 may allow a configuration administrator to setup a request form. The request form may be created by selecting and assembling one or more stored request templates. Request templates are described in more detail with respect to FIGS. 4 and 5.

Administration processor 320 may include hardware- and/or software-based logic to perform administrative management of requests on application server(s) 160. For example, administration processor 320 may allow a request administrator to retrieve information about a particular request, process the request, put the request on hold, etc. Information about a particular request may include, for example, due dates, requestor(s), approver(s), approval status, and the like.

Approval processor 330 may include hardware- and/or software-based logic to perform approval functions on behalf of application server(s) 160. For example, approval processor 330 may retrieve a request from, for example, data store 170, present the request to an approver, and accept user input regarding approval or denial of the request.

Request processor 340 may include hardware- and/or software-based logic to submit a request on application server(s) 160. For example, request processor 340 may allow a requestor to submit a request using a request form. In one implementation, request processor may retrieve a request form from request form engine 180, present the request form to a requester, and accept user inputs for the request form.

FIG. 4 provides a block diagram illustrating exemplary components of data store(s) 170 of FIG. 1. Data store(s) 170 may include one or more data repositories (e.g., databases) that store information associated with services provided by assignment workflow server 150 and other components in communication with assignment workflow server 150. In one implementation, data store(s) 170 may include a requests data store 410, a request templates reference data store 420, a request forms data store 430, and a request templates 440. In another implementation, requests data store 410, request templates reference data store 420, request forms data store 430, and request templates 440 may be distributed among two or more data stores.

Requests data store 410 may include one or more data repositories that store information associated with requests submitted through assignment workflow server 150. For example, requests data store 410 may include submitted requests and status information for submitted requests. Requests data store 410 may receive and store a request submitted by a requestor. Requests data store 410 may also receive and store approver actions and request administrator actions for each request.

Request templates reference data store 420 may include one or more data repositories that store information associated with request templates for workflow management system 100. For example, request templates reference data store 420 may include a list of available form templates, template controls, template values, and template attributes. A template control (also discussed in more detail with respect to request template 440 below) may be an element of a request form whose specific implementation depends on a particular computer system environment. A template value may be the name of a template or template control (for example, select box name, name of a selection in select box, input box name, radio button name, or checkbox name), the number of selections in select box, etc. A template attribute may be a background color, size of the font, the request form controls, etc. In one implementation, information stored in request templates reference data store 420 may be provided during initialization of workflow management system 100 (e.g., separate from any form configuration processes).

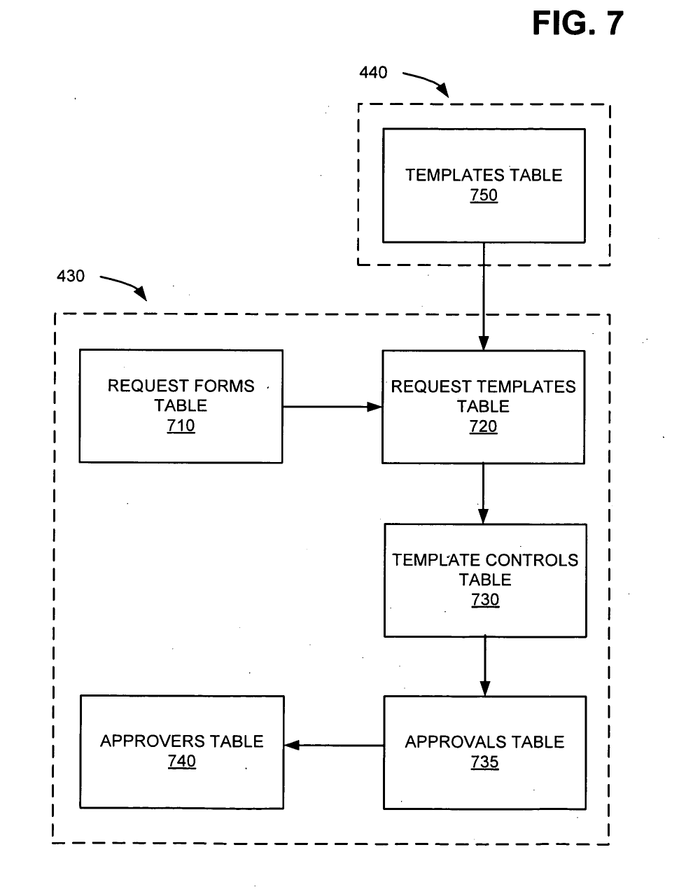

Request forms data store 430 may include one or more data repositories that store information associated with workflow request forms. For example, request forms data store 430 may include request forms configuration data, such as configuration records, for particular request forms. In one implementation, the request form configuration records may be stored in separate tables, such as a request forms table, a request templates table, a template controls table, an approvals table, and an approvers table. Further details of request forms data store 430 are provided below in connection with FIG. 7.

Request templates 440 may include one or more data repositories that store request templates for use in creating request forms. For example, in one implementation, request templates may be pre-designed sections of a request form that may have controls that can be manipulated by a user. Each template may be designed to fit the graphic design of workflow management system 100. In one implementation, request templates may be combined with other data (such as data from request forms data store 430) to provide a particular request form or request form segment. FIGS. 5A-5E provide some exemplary request templates with template form controls. FIG. 5A provides an exemplary request template with a text field template form control. FIG. 5B provides an exemplary request template with a select box template form control. FIG. 5C provides an exemplary request template with a multi select box template form control. FIG. 5D provides an exemplary request template with a radio buttons template form control. FIG. 5E provides an exemplary request template with a checkbox template form control. The data in each of the text field of FIG. 5A, the select box of FIG. 5B, the multi select box of FIG. 5C, the radio buttons of FIG. 5D, and the checkboxes of FIG. 5E is for illustrative purposes only.

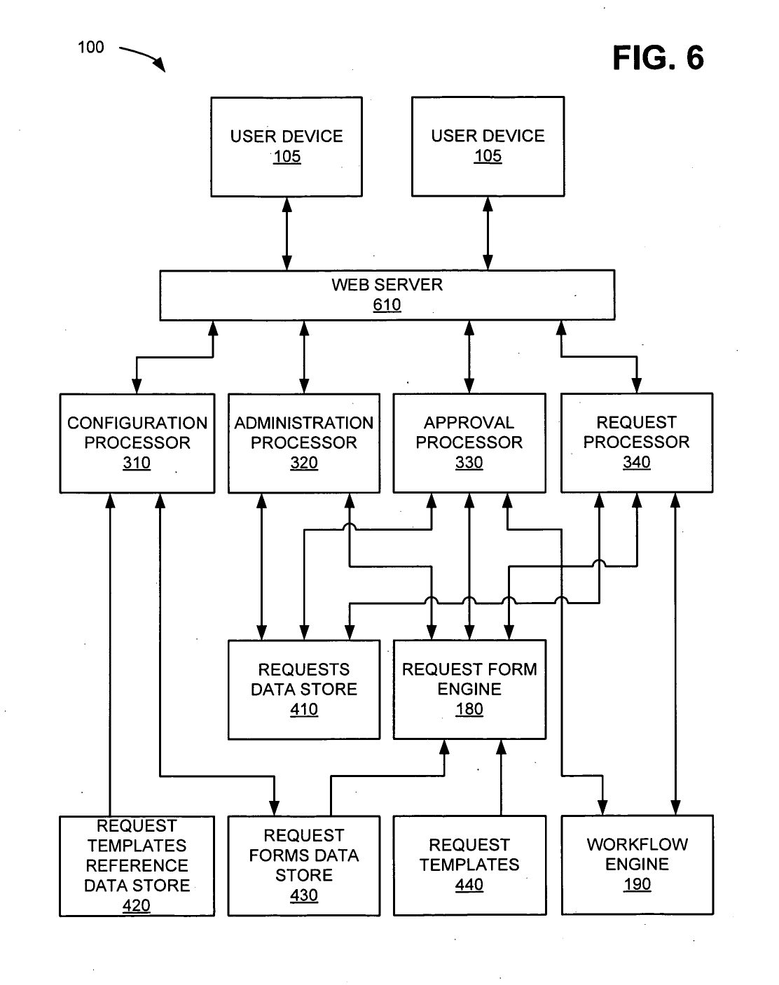

FIG. 6 provides a functional block diagram illustrating exemplary interaction of components of workflow management system 100. Users of system 100 may include, for example, configuration administrator 110, request administrator 120, approver 130, and requestor 140 using one or more user device 105. Each of configuration administrator 110, request administrator 120, approver 130, and requestor 140, may use a web browser within user device 105 to connect to the system 100 through a web server 610, which may be included in, for example, assignment workflow server 150. In one implementation, users may register and/or log in to workflow management system 100, e.g., by identifying herself/himself to a web-based application on the assignment workflow server 150. Users may be granted accounts with varying levels of access to workflow management system 100 based on, for example, a user's classification as a configuration administrator, a request administrator, an approver, or a requestor.

Through web server 610 (and as limited by restrictions that may be included with a user's account), a user may access configuration processor 310, administration processor 320, approval processor 330, and request processor 340. Configuration processor 310 may be configured to receive instructions from user device 105 (e.g., used by configuration administrator 110 of FIG. 1) to configure a request form. Configuration processor 310 may retrieve information from request templates reference data store 420. Configuration processor 310 may also retrieve information from and/or send information to request forms data store 430. Instructions for building a request form may include identifying one or more request templates (selected, for example, from request templates reference data store 420), defining positions of the templates on the request form, and/or defining the templates values and attributes.

Administration processor 320 may be configured to receive instructions from user device 105 (e.g., used by request administrator 120 of FIG. 1) via web server 610. Administration processor 320 may send information to, and/or receive information from, requests data store 410 and request form engine 180. Administration processor 320 may allow a request administrator to retrieve and update information about a particular request.

Approval processor 330 may be configured to deliver requests appropriate users for approval and to receive instructions from user device 105 (e.g., used by approver 130 of FIG. 1) via web server 610. Approval processor 330 may send information to, and/or receive information from, requests data store 410, request form engine 180, and workflow engine 190. For example, approver processor 330 may identify and send pending requests to the appropriate approver (such as approver 130) or administrator (such as request administrator 120) based on information from workflow engine 190. The approver at user device 105 may approve or reject the requests. Approver actions may be sent to and stored in requests data store 410. In one implementation, approver actions may be categorized as fully approved, partially rejected or fully rejected. Fully rejected requests may be closed and removed from the approver's and administrator's queue in requests data store 410. Approved or partially rejected requests may be processed according to the approval schema provided in the request. Thus, approved or partially rejected requests may be forwarded to additional approvers or marked as approved.

Request processor 340 may be configured to receive instructions from user device 105 (e.g., used by requestor 140 of FIG. 1) via web server 610. Request processor 340 may send information to, and/or retrieve information from, requests data store 410, request form engine 180, and workflow engine 190. In one implementation, requestor processor 340 may provide functions to authenticate a user (e.g., requestor 140) and to determine which request forms the user is authorized to submit. Upon initiation by the user, requestor processor 340 may launch a process to display a list of available request forms. The user may select and complete the request form, which may be submitted to request processor 340 as a request. The request may be passed to workflow engine 190, which determines the request status and assigns approvers to the request, based on the user's selection. The user's submitted request is stored in requests data store 410.

Request form engine 180 may send information to, and/or receive information from, administration processor 320, approval processor 330, and/or request processor 340. For example, when initiated by one of administration processor 320, approval processor 330, or request processor 340, request form engine 180 may retrieve information from request forms data store 430 and request templates 440 to assemble a request form. Each request form may be compiled and interpreted by request form engine 180 using layouts from request templates 440 and request form configuration data from request forms data store 420.

Requests data store 410 may send information to, and/or receive information from, administration processor 320, approval processor 330, and/or request processor 340. Request templates reference data store 420 may provide information to configuration processor 310. Request forms data store 430 may send information to and/or receive information from configuration processor 310. Request forms data store 430 may also send information to request form engine 180. Request templates data store 440 may provide information to request engine 180. For example, request form templates data store 440 along with request forms data store 430 may provide information to request form engine 180 in order to assemble and send a request form to administration processor 320, approval processor 330, or request processor 340. The assembled request form may be displayed on user device 105.

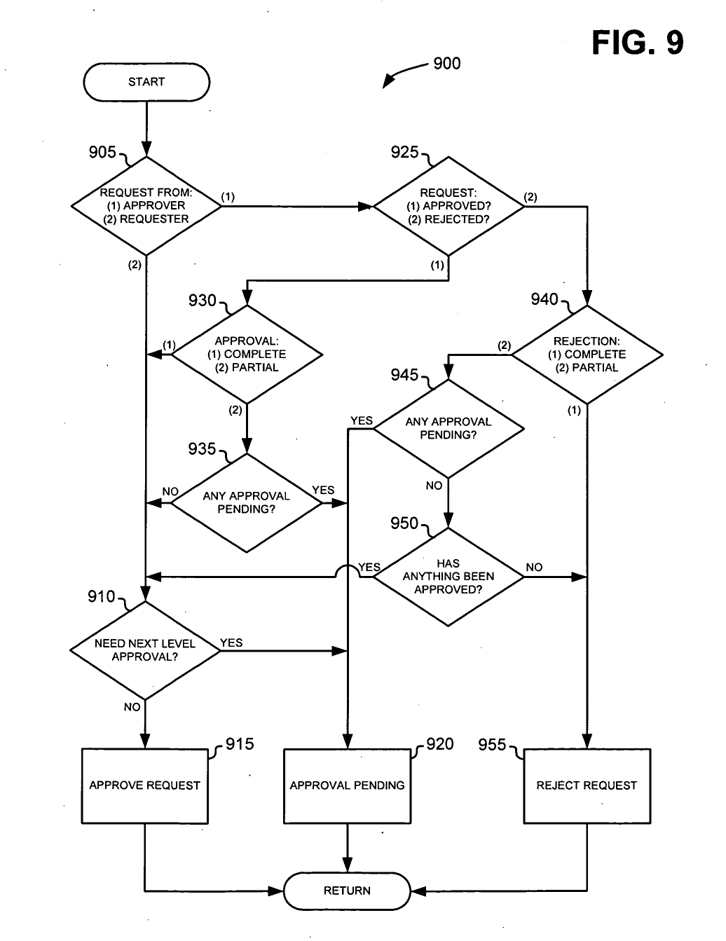

Workflow engine 190 may send information to, and/or receive information from, approval processor 330 and request processor 340. For example, workflow engine 190 may receive a new request from request processor 340. Workflow engine 190 may determine the request status and assign approvers to the request. The request status and the assigned approvers along with other request data may be stored in requests data store 410. Also, workflow engine 190 may receive a request from approval processor 330 and determine the new request status based on the approver 130 action, request history, and request form configuration data retrieved from request forms data store 430. Additional details of processes performed by workflow engine 190 are provided in FIG. 9.

FIG. 7 is a functional block diagram illustrating exemplary interaction of components of the request forms data store 430 of FIG. 4. Request forms data store 430 may contain configuration records for request forms. Request forms data store 430 may include request forms table 710, request templates table 720, template controls table 730, approvals table 735, and approvers table 740. Request forms table 710 may contain a request form skeleton records of particular request forms. A request form may be assembled from multiple request form templates. The aggregation of the request form templates for each particular request form may be stored in the request templates table 720. All request form templates that are available in a particular request system environment may be registered in templates table 750 of request templates 440. Request templates 440 may have controls associated with each request template. This control information may be stored for each request form in template controls table 730. Template controls may require approvals in one or more levels. The information about approvals may be stored in approvals table 735. Levels of approval may indicate a particular approval sequence is required (e.g., approval may first be required by a direct supervisor, before going to a facilities manager, then a higher level manager). For example, some template controls may only require approval after a lower level approval is received. Thus, in some implementations, a request form may require approvals at multiple levels. One or more approvers may be assigned to one approval. The information about assigned approvers may be stored in approvers table 740. Assigned approvers may be, for example, a particular person or a management position associated with one or more persons. Thus, a request form generated using request forms data store 430 may include an approver associated with multiple controls or associated with each control used in a particular request form.

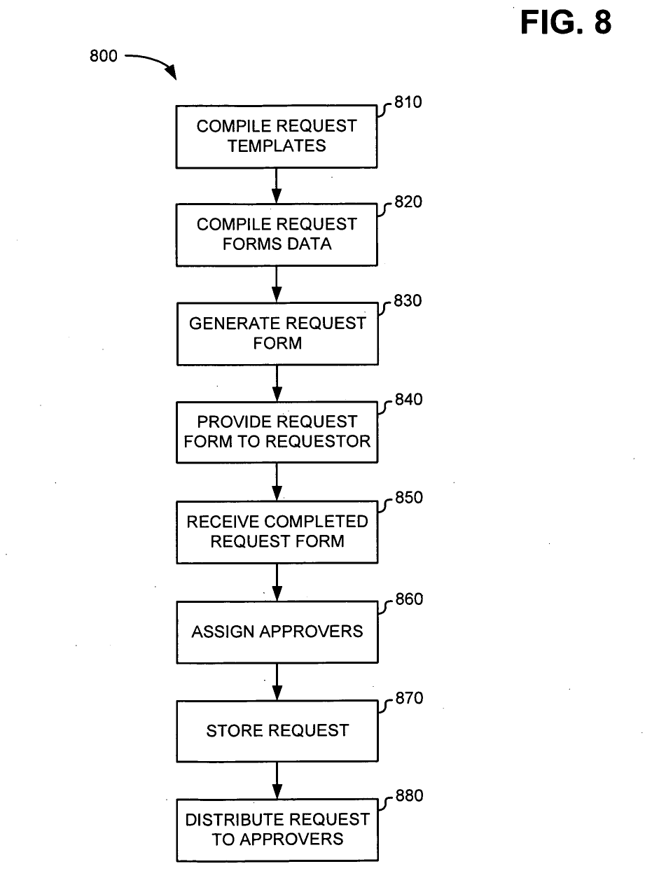

FIG. 8 is a flow chart 800 illustrating exemplary operations performed by workflow management system 100 of FIG. 1. Request templates may be compiled (block 810). For example, in one implementation, a network administrator may provide a group of form templates, including template controls, template values, and template attributes, during initial set up of workflow management system 100. The group of form templates may be subsequently customized and/or supplemented by other authorized users (such as configuration administrator 110). In another implementation, configuration administrator 110, using configuration processor 310 (accessed through web server 610), may compile a group of form templates. The form templates may be listed and/or categorized for later retrieval based on specific template features.

Request forms data may be compiled (block 820). For example, in one implementation, configuration administrator 110, using configuration processor 310 (accessed through web server 610), may compile request forms configuration data, such as configuration records that define the structure and data for a request form or group of request forms. Configuration data may also include, for example, a set of approvals and approvers or approver positions that may be applicable to a particular request form.

A request form may be generated (block 830). For example, request form engine 180 may use particular selections from the form templates compiled in block 810 and the request form data compiled in block 820 to generate a particular request form. The particular selections may be provided by, for example, configuration administrator 110. The request from may be generated based on a query from, for example, requester 140 or another user of workflow management system 100.

The request form may be provided to a requestor (block 840). For example, request form engine 180 may provide the generated request form to requestor 140 or another user of workflow management system 100 through, for example, request processor 340, web server 610, and/or network 195.

The completed request form may be received (block 850). For example, the request form may be completed by requestor 140 using user device 105. The request form may be submitted from user device 105 via network 195 and web server 610 to, for example, request processor 340. The request form may include requestor input for the request form, including all request controls that may be selected by requestor 140 to determine the request approvals and approvers.

Approvers may be assigned (block 860). For example, request processor 340 may pass the completed request form to workflow engine 190, which may assign approvers based on the user input provided in the competed request form. The request may be stored (block 870). For example, request processor 340 may also pass the completed request form to requests data store 410 for storing.

The request may be distributed to the approvers (block 880). For example, based on the request form approval setup, approver processor 330 may submit a request for approval to one or more approvers (e.g., approver 130) for approval of the particular request.

FIG. 9 is a flow chart 900 illustrating exemplary operations performed by workflow engine 190 of FIG. 1. For example, the process flow may be used by workflow engine 190 to determine a particular request status at any given time of the request workflow, as well as to determine and forward requests to the appropriate approvers. As described below, the request status may be based on the approver action (e.g., request may be approved or rejected), the request-approver configuration (e.g., the request may be approved partially or completely), and/or the previous approval actions (e.g., there might be partial approvals or rejections).

A request may be identified as coming from an approver or a requester (block 905). For example, status requests coming from a request processor (such as request processor 340) may be identified by workflow engine 190 as coming from a requestor. Status requests coming form an approval processor (such as approval processor 330) may be identified by workflow engine 190 as coming from an approver.

If the request is identified in block 905 as coming from a requester, it may be determined if a next approval level is needed (block 910). For example, workflow engine 190 may identify whether the request contains higher level approvals that have not been completed. If no next level approval is needed, the request may be deemed approved (block 915). If a next level approval is needed, the request may be identified as approval pending (block 920).

Returning to block 905, if the request is identified as coming from an approver, the request may be identified as being approved or rejected (block 925). For example, workflow engine 190 may review approver actions for the particular request to identify whether an approver has approved or rejected the requests.

If the request is identified as being approved in block 925, the approval may be identified as being complete or partial (block 930). For example, workflow engine 190 may review approver action for the particular request to identify whether an approver approval was partial or complete. For example, a request may have multiple parts, only some of which are approved. As another example, a request may be approved with certain conditions or restrictions. If the approval is identified as being complete in block 930, the inquiry may return to determining if a next approval level is needed (block 910) and proceed as described above. If the approval in block 930 is identified as being partial, the inquiry may identify whether or not an approval is pending (block 935). If no pending approval is identified in block 935, the inquiry may return to determining if a next approval level is needed (block 910) and proceed as described above. If a pending approval is identified in block 935, the request may be identified as approval pending (block 920).

If the request in block 925 is identified as being rejected, the rejection may be identified as being complete or partial (block 940). For example, workflow engine 190 may review approver actions for the particular request to identify whether an approver rejection was partial or complete. If the rejection in block 940 is identified as being partial, the inquiry may identify whether or not an approval is pending (block 945). If a pending approval is identified in block 945, the request may be identified as approval pending (block 920).

If no pending approval is identified in block 945, the request may be reviewed to identify if any aspects of the request have been approved (block 950). For example, workflow engine 190 may review approver actions for the particular request to identify whether the request has received partial or complete approval at any level. If no approvals for the request have been identified in block 950, the request may be deemed rejected (block 955). If a part of the request is identified as being approved in block 950, the inquiry may return to determining if a next approval level is needed (block 910) and proceed as described above. If the rejection in block 940 is identified as being complete, the request may be deemed rejected (block 955).

Thus, summarizing the above flow chart 900, completely approved requests or partially approved requests with no pending approvals and no next level approvers are considered approved requests. Completely or partially rejected requests with no partial approval pending are considered rejected. Approved requests with the next level approval required or the requests with partial current level approval pending are kept as approval pending status. The information about the request status and the next level approvers may be returned back to the rendering processor (e.g., approval processor 330 or request processor 340).

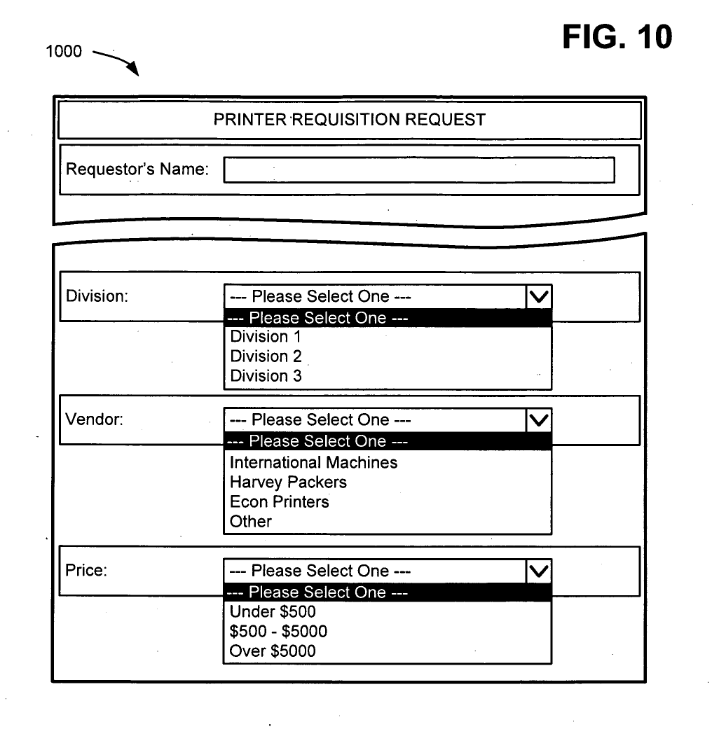

FIG. 10 provides sections of an exemplary approval form 1000 according to implementations described herein. Approval form 1000 is used herein as an example of how systems and methods described herein maybe used to configure and submit a request form for printers. For this example, assume a company has three divisions, each with different approval processes as follows:
Division 1 has only one approval level. The approval depends on the vendor for the printer. Particularly, Division 1 has different approvers for the vendors “International Machines,” “Harvey Packers,” and “Econ Printers,” with a separate approver for other vendors.
Division 2 has one approval level. The approval depends on the price of the printer. Particularly, Division 2 has different approvers for the printers costing below $500, between $500 and $5000, and over $5000.
Division 3 has two approval levels. The first approval level is a vendor-based approval, similar to that of Division 1. The second approval level is a price-based approval, similar to that of Division 2.

Based on the approval guidelines for each of Division 1, Division 2, and Division 3, a configuration administrator (such as configuration administrator 110 of FIG. 1 instructing configuration processor 310 of FIG. 3) may assemble a request form that includes (among other items) three select boxes: a “Division” select box, a “Vendor” select box, and a “Price” select box. All three select boxes may use one or more select box templates from the request templates data store 440. Proper approvals may be set up for each division, so that, in the particular example of FIG. 10, the controls for the request form are the selections in each select box. The configuration administrator may assign approvers for each approval option in the “Division” select box, “Vendor” select box, and “Price” select box, based on the approval guidelines.

When a requestor (such as requestor 140 of FIG. 1 instructing request processor 340 of FIG. 3) initiates a request for a new printer, request form engine 180 may generate the form (partially displayed in form 1000) based on the instructions assembled by the configuration administrator. Using the provided printer requisition request form 1000 the requestor may select a division, vendor and price corresponding to the requested printer. When the requestor selects a division/vendor/price combination, the resulting request will be automatically assigned to the proper approvers, based on the approvers assigned to the various form selections.

Once the request form is submitted by the requester, the printer request may be automatically routed to the first level approver (such as approver 130 of FIG. 1 interacting with approval processor 330 of FIG. 3). Upon action by the first level approver, the printer request may be routed to the second level approver (particularly for a Division 3 request, in the present example). After the request has been approved at all levels, the request may be forwarded to a request administrator (such as request administrator 120 of FIG. 1 instructing administration processor 320 of FIG. 3) for processing. For the approved printer requisition, the request administrator may be, for example, a purchasing department official.

Methods and systems described herein may allow a request form to be created using predesigned request form templates and controls. Request templates including pre-designed sections of a request form may be compiled; and request forms data including configuration data for a particular request form may be compiled. Based on the compiled data a particular request form may be automatically generating based on the request templates and the request forms data. The request form may be provided over a network to a user device for completion. When the completed request form is received from the user device, it may be processed as a request, including automatically assigning one or more approvers for the request based on information in the completed request form, storing data from the completed request form, and automatically routing the request over the network for approval by one or more of the approvers.

The foregoing description provides illustration and description, but is not intended to be exhaustive or to limit the embodiments to the precise form disclosed. Modifications and variations are possible in light of the above teachings or may be acquired from practice of systems and methods disclosed herein.

Also, while series of blocks have been described with regard to the flowchart of FIGS. 8 and 9, the order of the blocks may differ in other implementations. Further, non-dependent acts may be performed in parallel.

Implementations described herein may be implemented in methods and/or computer program products. Accordingly, implementations may be embodied in hardware and/or in software (including firmware, resident software, micro-code, etc.). Furthermore, implementations described herein may take the form of a computer program product on a computer-usable or computer-readable storage medium having computer-usable or computer-readable program code embodied in the medium for use by or in connection with an instruction execution system. The actual software code or specialized control hardware used to implement the systems and methods described herein is not limiting. Thus, the operation and behavior of the implementations were described without reference to the specific software code—it being understood that software and control hardware could be designed to achieve implementations based on the description herein.

Further, certain implementations described herein may be implemented as “logic” that performs one or more functions. This logic may include hardware—such as a processor, microprocessor, an application specific integrated circuit or a field programmable gate array—or a combination of hardware and software.

It should be emphasized that the term “comprises/comprising” when used in this specification is taken to specify the presence of stated features, integers, steps, or components, but does not preclude the presence or addition of one or more other features, integers, steps, components, or groups thereof.

Even though particular combinations of features are recited in the claims and/or disclosed in the specification, these combinations are not intended to limit the invention. In fact, many of these features may be combined in ways not specifically recited in the claims and/or disclosed in the specification.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the phrase “based on,” as used herein is intended to mean “based, at least in part, on” unless explicitly stated otherwise.

What is claimed is:

1. A method, comprising:
compiling request templates, the request templates comprising pre-designed sections of a request form;
compiling request forms data, the request forms data comprising configuration data for a particular request form;
automatically generating a request form based on the request templates and the request forms data;
providing the request form over a network to a user device;
receiving the completed request form from the user device, the request form configured to be processed as a request;
automatically assigning one or more approvers for the request based on information in the completed request form;
storing data from the completed request form; and
automatically routing the request over the network for approval by the one or more approvers.

2. The method of claim 1, where the request templates include controls to be manipulated by a user.

3. The method of claim 1, further comprising:
monitoring approval of the request by the one or more approvers.

4. The method of claim 1, further comprising:
receiving an approval decision by the one of the one or more approvers; and
automatically routing the request over the network for approval by another of the one or more of the approvers.

5. The method of claim 4, further comprising:
storing data from the approval decision by the one of the one or more approvers; and
associating the stored data from the approval decision by the one of the one or more approvers with the stored data from the completed request form.

6. The method of claim 4, where the approval decision is one of an approval, a partial approval, or a rejection, and where the automatically routing the request over the network for approval by another of the one or more of the approvers is based on the approval decision.

7. The method of claim 1, where the request form data further comprises:
a request form table, a request templates table, a request form controls table, a request form approvals table, and a request form approvers table.

8. The method of claim 1, further comprising:
receiving a status request for the request from an approver or a requestor;
automatically determining the approval status for the request; and
providing the approval status to the approver or the requester.

9. A system, comprising:
a workflow assignment server, the workflow assignment server including a web server to allow a user device to communicate with the system over a network;
one or more application servers, the one or more application servers including one or more processors to manage a configuration process, an administration process, a requests process, or an approval process initiated by the user device;
one or more data stores, the one or more data stores including request templates and one or more sets of data to configure a request form;
a request form engine for assembling a request form based on the request templates and the one or more sets of data, the assembling being initiated by a signal from one of the one or more application servers; and
a workflow engine to receive a completed request form from one of the one or more application servers, the workflow engine including processing logic to process the completed request form as a request and to automatically assign one or more approvers for the request.

10. The system of claim 9, where the request templates include controls to be manipulated by a user.

11. The system of claim 9, where the workflow engine automatically routes the request to the one or more approvers.

12. The system of claim 11, where the one or more data stores further comprises:
a requests data store to store the request, where the application server receives an approval decision from one of the one or more approvers and where the approval decision is stored in the requests data store and associated with the request.

13. The system of claim 9, where the workflow engine receives a request and automatically provides an approval status for the request.

14. The system of claim 9, where the one or more sets of data to configure the request form comprises one or more template controls, and where an approver is associated with the one or more template controls.

15. The system of claim 9, where the approval process accepts input from the user device indicating approval, partial approval, or rejection of the request, and where the workflow engine automatically routes the request for approval by another of the one or more of the approvers based on the input from the user device.

16. The system of claim 9, where the workflow assignment server stores user accounts with varying levels of access to the workflow management system based on a user's classification as one or more of a configuration administrator, a request administrator, an approver, or a requestor.

17. A computer-readable memory comprising computer-executable instructions, the computer-readable memory comprising:
one or more instructions to generate a request form based on request templates and request forms data, the request templates comprising pre-designed sections of a request form and the request forms data comprising configuration data for a particular request form;
one or more instructions to provide the request form over a network to a user device;
one or more instructions to receive a completed request form from the user device;
one or more instructions to process the complete request form as a request;
one or more instructions to assigning one or more approvers for the request based on information in the completed request form;
one or more instructions to automatically route the request to the one or more approvers.

18. The computer-readable memory of claim 17, further comprising:
one or more instructions to receive an approval decision from a user; and
one or more instructions to store the request and the approval decision.

19. A system comprising:
means for compiling request templates, the request templates comprising pre-designed sections of a request form;
means for compiling request forms data, the request forms data comprising configuration data for a particular request form;
means for automatically generating a request form based on the request templates and the request forms data; and
means for providing the request form over a network to a user device.

20. The system of claim 19, further comprising:
means for receiving the completed request form from the user device, the request form configured to be processed as a request;
means for automatically assigning one or more approvers for the request based on information in the completed request form;
means for storing data from the completed request form; and
means for automatically routing the request over the network for approval by the one or more approvers.
